(19) United States
(12) Patent Application Publication
(10) Pub. No.: US 2014/0099516 A1
(43) Pub. Date: Apr. 10, 2014

(54) BRAZED ARTICLES AND METHODS OF MAKING THE SAME

(71) Applicant: GENERAL ELECTRIC COMPANY, Schenectady, NY (US)

(72) Inventors: Mark Lawrence Hunt, Simpsonville, SC (US); Gary Charles Shubert, Woodruff, SC (US); Jerry Ellison Gould, Grandview Heights, OH (US)

(73) Assignee: GENERAL ELECTRIC COMPANY, Schenectady, NY (US)

(21) Appl. No.: 13/645,951

(22) Filed: Oct. 5, 2012

(51) Int. Cl. B32B 15/01; F03B 11/02; F01D 5/14; B23K 20/24

(52) U.S. Cl. 428/615; 228/203; 415/208.1; 416/223 R

(57) ABSTRACT

An article comprising a substrate, the substrate having a surface; a diffusion barrier layer disposed on a portion of the surface of the substrate, a brazing layer disposed on the diffusion barrier layer, the brazing layer comprising at least one diffusible element, wherein the diffusion barrier layer inhibits the at least one diffusible element from diffusing into the diffusion barrier layer and the substrate. Also provided herein is a method of making an article comprising providing a substrate, the substrate having a surface; forming a diffusion barrier layer on a portion of the surface of the substrate, the diffusion barrier layer being formed by electro-spark deposition; forming a brazing layer on the diffusion barrier layer, the brazing layer comprising at least one diffusible element, wherein the diffusion barrier layer inhibits the at least one diffusible element from diffusing into the substrate.

### BACKGROUND OF THE INVENTION

The subject matter disclosed herein relates to brazed articles, such as gas turbine engine components, and more particularly to brazed articles which reduce or inhibit diffusion of at least one diffusible element present in a brazing material from diffusing into a substrate, and methods of making the same.

Brazing and welding are methods for combining a metal base material, or substrate, with a metal filler material. More specifically, brazing is a process in which a metal filler material is heated above its melting temperature, applied to a metal base material and cooled to join the metal filler material and the metal base material together. Flux is often added to the metal filler material to prevent oxides from forming while the metal is heated in brazing procedures conducted outside of an inert environment. Other methods of brazing include the use of an inert environment such as vacuum or inert gas. Various other elements are included in the metal filler material to improve the mechanical and thermal properties of the metal filler material.

Brazing is used as a method to repair damaged areas of a metal substrate of an article, such as a component used in a gas turbine engine. Damaged areas are blended away and additional material is added using the metal filler material. Brazing is used to repair articles which require structural and/or aerodynamic integrity in order to operate effectively in a given application.

One disadvantage associated with current brazing methods, and articles produced therefrom, is the diffusion of certain elements present in the filler metal material into the metal base material. Diffusible elements present in the filler metal material such as boron, silicon, and/or phosphorus diffuse into and interact with the metal base material, resulting in formation of intermetallic compounds or other deleterious metallurgical phases. These intermetallic compounds lead to embrittlement, cracking and/or corrosion of the metal base material, thereby weakening the repaired area and reducing the mechanical properties and performance of the article.

It is therefore desirable to provide brazed articles and methods of making the same which solve one or more of the aforementioned problems.

### BRIEF DESCRIPTION OF THE INVENTION

According to one aspect of the invention, an article comprises a substrate, the substrate having a surface; a diffusion barrier layer disposed on a portion of the surface of the substrate, a brazing layer disposed on the diffusion barrier layer, the brazing layer comprising at least one diffusible element, wherein the diffusion barrier layer inhibits the at least one diffusible element from diffusing into the diffusion barrier layer and the substrate.

According to another aspect of the invention, a method of making an article comprises providing a substrate, the substrate having a surface; forming a diffusion barrier layer on a portion of the surface of the substrate, the diffusion barrier layer being formed by electro-spark deposition; forming a brazing layer on the diffusion barrier layer, the brazing layer comprising at least one diffusible element, wherein the diffusion barrier layer inhibits the at least one diffusible element from diffusing into the substrate.

These and other advantages and features will become more apparent from the following description taken together in conjunction with the accompanying drawings.

### BRIEF DESCRIPTION OF THE DRAWINGS

The subject matter, which is regarded as the invention, is particularly pointed out and distinctly claimed in the claims at the conclusion of the specification.

The foregoing and other features, and advantages of the invention are apparent from the following detailed description taken in conjunction with the accompanying drawings in which:

FIG. 1 is a partial cross-sectional view of a prior art article; and

FIG. 2 is a partial cross-sectional view of an article.

FIG. 3 is a partial cross-sectional view of an article.

The detailed description explains embodiments of the invention, together with advantages and features, by way of example with reference to the drawings.

### DETAILED DESCRIPTION OF THE INVENTION

Embodiments described herein generally relate to brazed articles and methods of making the same. A diffusion barrier layer is provided for use in conjunction with a substrate and a brazing layer to repair a portion of a substrate.

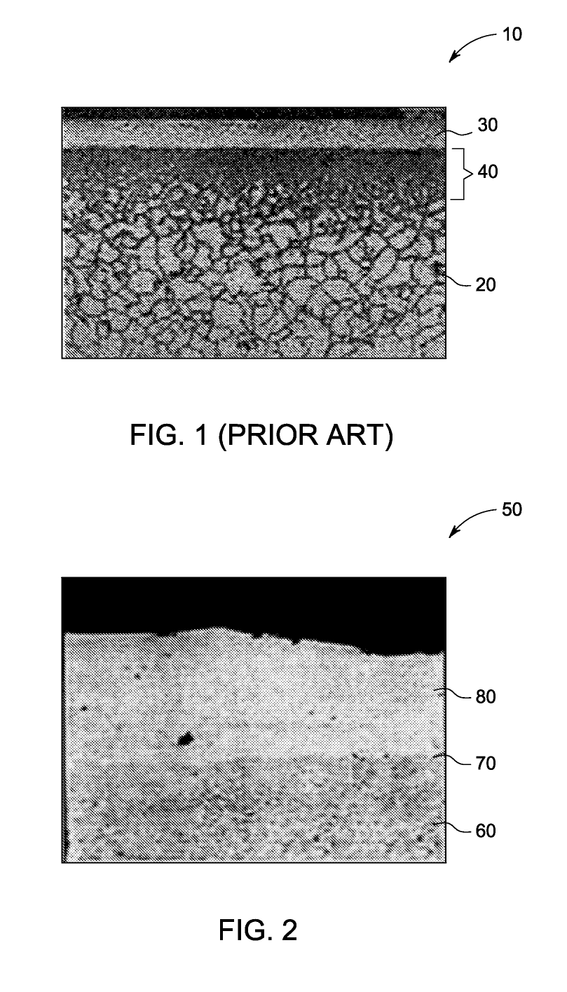

Referring to FIG. 1, a prior art article 10 which has been subjected to a brazing repair comprises a substrate 20 and a brazing layer 30. After the brazing layer 30 is deposited on the substrate 20, a braze diffusion zone 40 is formed in the substrate 20. The braze diffusion zone 40 is formed by the diffusion, or migration, of at least one diffusible element (not shown) present in the brazing layer 30 into the substrate 20. As used herein, the term “diffusible element” refers to an element which is present in the brazing layer 30 and which is capable of forming an intermetallic compound with another element present in the substrate 20.

Referring to FIG. 2, an article 50 comprises a substrate 60 having a surface 70. A diffusion barrier layer 80 is disposed on a portion of the surface 70 of the substrate 60.

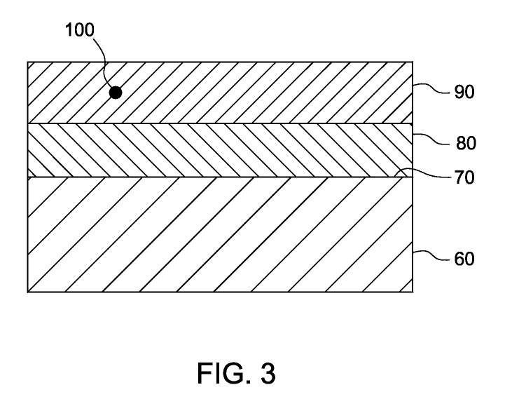

Referring to FIG. 3, the article 50 further comprises a brazing layer 90. A brazing layer 90 is disposed on the diffusion barrier layer 80. The brazing layer 90 comprises at least one diffusible element 100. The diffusion barrier layer 80 inhibits the at least one diffusible element 100 from diffusing from the brazing layer 90 into the diffusion barrier layer 80 and/or the substrate 60.

The substrate 60 comprises a cast metal base material. As used herein, the term “alloy” refers to a mixture or a solid-solution having metallic properties and composed of two or more chemical elements of which at least one is a metal. As used herein, the term “alloy” is inclusive of one or more superalloys. As used herein, the term “superalloy” refers to an alloy capable of withstanding high temperatures, high stresses, and/or high oxidation conditions. The metal base material is at least one metal, a metal compound, an alloy or a superalloy. Examples of suitable metals for use in the metal base material include, but are not limited to nickel, chromium, cobalt, aluminum, titanium, molybdenum, tungsten and tantalum or a combination comprising at least one of the foregoing.

In one embodiment, the base alloying element of the metal base material is nickel, cobalt or nickel-iron. As used herein, the term “base alloying element” refers to an element present in the alloy, or base metal material, in an amount equal to and/or greater than about 50 wt %, based on the total weight of the alloy. In another embodiment, the base alloying element of the metal base material is nickel. In yet another embodiment, the metal base material is a nickel-based superalloy wherein nickel is the base alloying element.

In one embodiment, the metal base material comprises nickel, chromium, cobalt, aluminum, titanium, molybdenum, tungsten and tantalum. In another embodiment, the metal base material comprises about 50 wt % to about 70 wt % nickel, about 5 wt % to about 25 wt % chromium, about 5 wt % to about 15 wt % cobalt, about 0.1 wt % to about 10 wt % aluminum, about 0.1 wt % to about 10 wt % titanium, about 0.1 wt % to about 5.0 wt % molybdenum, about 0.01 wt % to about 0.50 wt % tungsten and about 0.1 wt % to about 10.0 wt % tantalum, based on the total weight of the metal base material.

In yet another embodiment, the metal base material comprises about 55 wt % to about 65 wt % nickel, about 10 wt % to about 20 wt % chromium, about 7 wt % to about 13 wt % cobalt, about 1 wt % to about 5 wt % aluminum, about 2 wt % to about 8 wt % titanium, about 0.5 wt % to about 3 wt % molybdenum, about 0.05 wt % to about 0.3 wt % tungsten and about 1.0 wt % to about 5.0 wt % tantalum, based on the total weight of the metal base material.

In one embodiment, the metal base material is a GTD-111™ superalloy. The GTD-111™ superalloy is a nickel-base superalloy, available from the General Electric Company, which is designed to withstand creep damage occurring in the first and second and/or later stage blades of gas turbine engines. The GTD-111™ superalloy has a multiphase structure consisting of a y matrix and a γ′ precipitate. The GTD-111™ superalloy has a chemical composition of about 60.5 wt % nickel, about 14 wt % chromium, about 9.5 wt % cobalt, about 3.0 wt % aluminum, about 4.9 wt % titanium, about 1.5 wt % about molybdenum, about 0.1 wt % tungsten and about 2.8 wt % tantalum, based on the total weight of the chemical composition.

In one embodiment, the diffusion barrier layer 80 is applied directly to a damaged area of the substrate 60. In another embodiment, prior to deposition of the diffusion barrier layer 80, the damaged area is blended away or otherwise removed from the substrate 60. In another embodiment, the damaged area is blended away or otherwise removed from the substrate 60 and then the area of the substrate 60 to be repaired is cleaned. Examples of suitable cleaning methods include, but are not limited to, chemical, mechanical, nickel-plate, furnace, or hydrogen fluoride cleaning methods.

The damaged area of the article 50 is repaired by deposition of the diffusion barrier layer 80 and the material addition of the brazing layer 90 to restore the original or desired structural integrity, aerodynamic performance and/or fit and dimensions of the article. In one embodiment, the brazing layer 90 is used to join a replacement section (not shown) to the substrate 60. The diffusion barrier layer 80 is deposited on the replacement section, the substrate 60, or both, prior to deposition of the brazing layer 90.

The damaged area to be repaired is of any size which is capable of being repaired using brazing methods. In one embodiment, the damaged area has a diameter of from about 0.1 mm to about 20 mm and a depth of about 0 1 mm to about 5 mm.

The diffusion barrier layer 80 is a diffusion barrier material comprising at least one refractory metal. Examples of suitable refractory metals include niobium, molybdenum, tantalum, tungsten, rhenium, titanium, vanadium, chromium, zirconium, hafnium, ruthenium, rhodium, osmium, iridium or a combination comprising at least one of the foregoing.

The at least one refractory metal has a melting point of between about 2400° C. and about 3500° C. In one embodiment, the at least one refractory metal has a melting point of greater than about 2000° C. In another embodiment, the at least one refractory metal has a melting point of greater than about 2300° C. In yet another embodiment, the at least one refractory metal has a melting point of greater than about 2500° C.

In one embodiment, the diffusion barrier layer 80 is a nickel-base alloy or superalloy comprising at least one refractory metal. In another embodiment, the diffusion barrier layer 80 is a nickel-base alloy or superalloy comprising at least one refractory metal selected from niobium, molybdenum, tantalum, tungsten, rhenium or a combination comprising at least one of the foregoing.

In one embodiment, the diffusion barrier layer 80 has a total refractory metal content of from about 10 wt % to about 100 wt %, based on the total weight of the diffusion barrier layer 80. In another embodiment, the diffusion barrier layer has a total refractory metal content of equal to or greater than about 50 wt %, based on the total weight of the diffusion barrier layer 80. In yet another embodiment, the diffusion barrier layer has a total refractory metal content of equal to or greater than about 75 wt %, based on the total weight of the diffusion barrier layer 80. In still yet 260340-1 another embodiment, the diffusion barrier layer has a total refractory metal content of equal to or greater than about 85 wt %, based on the total weight of the diffusion barrier layer 80.

The diffusion barrier layer 80 is directly deposited onto a portion of the surface 70 of the substrate 60 using electrospark deposition (ESD). ESD is a pulse micro-welding method having an implied millisecond duration thermal cycle at temperatures between about 8,000° C. to about 25,000° C. Using ESD, the diffusion barrier layer 80 is applied to a portion of a surface 70 of the substrate 60 via electric sparks. Both the deposition and the cooling, or self-quenching, of the diffusion barrier layer 80 are rapid. Due to the short duration of the thermal pulses, the substrate 60 is subjected to only low heat input during the ESD process. The microstructure of the substrate 60 following deposition of the diffusion barrier layer 80 using ESD is the same or substantially the same as the microstructure of the substrate 60 before deposition of the diffusion barrier layer 80 on the substrate 60. Deposition of the diffusion barrier layer 80 via ESD results in the formation of a metallurgical bond between the diffusion barrier layer and the substrate 60.

The diffusion barrier layer 80 is built up to a desired thickness by repeatedly overlaying deposits of the diffusion barrier layer material. Each of the deposits which cumulatively form the diffusion barrier layer 80 has a substantially uniform or uniform thickness. Each of the deposits which cumulatively form the diffusion barrier layer 80 has an average thickness of about 1 μm to about 5 μm. The resulting diffusion barrier layer 80 has an average thickness of about 1 μm to about 500 μm.

The brazing layer 90 comprises a cast filler metal material. The filler metal material is an alloy or a superalloy. Examples of suitable metals for use in the filler metal material include, but are not limited to, aluminum, copper, silver, copper, zinc, gold, nickel, or a combination comprising at least one of the foregoing.

The particular filler metal material is selected according to the desired properties and use of the article. Such properties include, but are not limited to, the strength of the filler metal material, the coefficient of expansion of the filler metal material, the melting point of the filler metal material, the related properties of the diffusion barrier material of the diffusion barrier layer 80 and the metal base material of the substrate 60, and the operating conditions to which the article is subjected. Additional considerations include the wettability and grain structure of the filler metal material as well as post-brazing procedures such as hardening heat treatments for various durations of time.

In one embodiment, the filler metal material is a nickel-based alloy. In another embodiment, the filler metal material is a nickel-based superalloy. In yet another embodiment, the filler metal material is a nickel-cobalt-based superalloy. In still another embodiment, the filler metal material is a boron-treated nickel-based superalloy. In still yet another embodiment, the filler metal material comprises nickel, cobalt, chromium, niobium, tantalum, molybdenum or a combination comprising at least one of the foregoing.

In one embodiment, the filler metal material is Amdry™ D-15 Diffusion Braze Alloy available from Sulzer Metco Inc. The composition of Amdry™ D-15 Diffusion Braze Alloy is about 15.3 wt % chromium, about 10.3 wt % cobalt, about 3.5 wt % tantalum, about 3.5 wt % aluminum, about 2.3 wt % boron, and a balance of nickel. The filler metal material has a liquidus temperature of equal to or greater than about 450° C. and below the solidus of the diffusion barrier material of the diffusion barrier layer 80. In one embodiment, the filler metal material has a brazing temperature range of from about 450° C. to about 1400° C. As used herein, the term “liquidus” refers to the temperature at which a metal or an alloy is entirely liquid. As used herein, the term “solidus” refers to the temperature at which a metal or an alloy is entirely solid.

The filler metal material is used in various forms, including but not limited to, braze powder, braze paste, braze tape, braze preforms, braze foil, braze rods or wires. Depending on the particular type of brazing and the environmental conditions selected, the filler metal material may further comprise a flux material to reduce or prevent the formation of oxides.

The filler metal material used to form the brazing layer 90 further comprises at least one diffusible element 100. Examples of the at least one diffusible element 100 include, but are not limited to, boron, phosphorus, silicon, or a combination comprising at least one of the foregoing. In one embodiment, the at least one diffusible element 100 is boron. In another embodiment, the at least one diffusible element 100 is a melting point suppressant.

The diffusion of an at least one diffusible element 100 is measured using the Arrhenius equation (1):

D=Dₒe^{-Q/kT} (1)

where D is the diffusivity, or diffusion rate, Dₒ is the pre-exponential diffusion constant, Q is the activation energy, k is the Boltzmann constant, and T is the absolute temperature. Diffusivity is categorized according to Dₒ and Q.

The diffusion of the at least one diffusible element 100 is also determined by measuring the microhardness of the surface 70 of the substrate 60. Referring back to the prior art article of FIG. 1, when a diffusible element (not shown) diffuses from a brazing layer 30 into the substrate 20 to form the braze diffusion zone 40, the interaction between the diffusible element and the metal base material of the substrate 20 result in the formation of an intermetallic compound. For example, diffusible elements such as boron in boron-containing nickel-base alloys interact with the base metal material of the substrate 20 to form boride particles. The surface of the substrate 20 is then analyzed for the presence of intermetallic compounds such as boride particles.

Referring back again to FIGS. 2 and 3, the surface 70 of the substrate 60 is similarly analyzed for the reduction or absence of such intermetallic compounds. In one embodiment, the diffusion barrier layer 80 reduces or inhibits the diffusion of the at least one diffusible element 100 into the substrate 60. In another embodiment, the diffusion barrier layer 80 inhibits the diffusion of the at least one diffusible element 100 into the diffusion barrier layer 80 and the substrate 60. In yet another embodiment, the diffusion barrier layer 80 inhibits any diffusible element 100 present in the brazing layer 90 from diffusing into the substrate 60. In still yet another embodiment, the diffusion barrier layer 80 inhibits any diffusible element 100 present in the brazing layer 90 from diffusing into the diffusion barrier layer 80 and the substrate 60.

Also provided herein is a method of making the article 50 comprising providing a substrate 60, the substrate 60 having a surface 70; forming a diffusion barrier layer 80 on a portion of the surface 70 of the substrate 60, the diffusion barrier layer 80 being formed by electro-spark deposition; forming a brazing layer 90 on the diffusion barrier layer 80, the brazing layer 90 comprising at least one diffusible element 100, wherein the diffusion barrier layer 80 reduces and or inhibits the at least one diffusible element 100 from diffusing into the substrate 60.

In one embodiment, the article 50, and more specifically the surface 70 of the substrate 60, exhibits an improvement in at least one mechanical property selected from the group consisting of improved wear resistance, corrosion resistance and crack resistance when compared to an article which is devoid of the diffusion barrier layer 80. In another embodiment, the diffusion barrier layer 80 results in the elimination of crack formation at the surface 70 of the substrate 60. In yet another embodiment, the incorporation of the diffusion barrier layer 80 between the substrate 60 and the brazing layer 90 results in reduced fatigue and/or increases the lifetime of the article 50.

Examples of the brazed articles described herein include, but are not limited to, a power generation device, a gas turbine engine component, a turbine bucket, a turbine blade, a vane, a shroud, a liner, a combustor, a transition piece, a rotor component, an exhaust flap, a seal or a fuel nozzle.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An article comprising:
a substrate, the substrate having a surface;
a diffusion barrier layer disposed on a portion of the surface of the substrate; and
a brazing layer disposed on the diffusion barrier layer, the brazing layer comprising at least one diffusible element,
wherein the diffusion barrier layer inhibits the at least one diffusible element from diffusing into the diffusion barrier layer and the substrate.

2. The article of claim 1, wherein the substrate comprises at least one alloy or superalloy.

3. The article of claim 1, wherein the diffusion barrier layer comprises at least one refractory metal.

4. The article of claim 1, wherein the brazing layer comprises at least one alloy or superalloy.

5. The article of claim 1, wherein the at least one diffusible element comprises boron, silicon, phosphorus or a combination comprising at least one of the foregoing.

6. The article of claim 1, wherein the diffusion barrier layer forms a metallurgical bond with the substrate.

7. The article of claim 1, wherein the article is a power generation device.

8. The article of claim 1, wherein the article is a gas turbine engine component.

9. The article of claim 1, wherein the substrate comprises a turbine blade, vane, shroud, liner, combustor, transition piece, rotor component, exhaust flap, seal or fuel nozzle.

10. The article of claim 1, wherein the substrate exhibits less degradation than the same article which is devoid of the diffusion barrier layer.

11. The article of claim 1, wherein the diffusion barrier layer has a total refractory metal content of from about 10 wt % to about 100_wt %, based on a total weight of the diffusion barrier layer.

12. A method of making an article, comprising:
providing a substrate, the substrate having a surface;
forming a diffusion barrier layer on a portion of the surface of the substrate, the diffusion barrier layer being formed by electro-spark deposition;
forming a brazing layer on the diffusion barrier layer, the brazing layer comprising at least one diffusible element,
wherein the diffusion barrier layer inhibits the at least one diffusible element from diffusing into the substrate.

13. The method of claim 12, wherein the substrate comprises at least one alloy or superalloy.

14. The method of claim 12, wherein the diffusion barrier layer comprises at least one refractory metal.

15. The method of claim 12, wherein the brazing layer comprises at least one alloy or superalloy.

16. The method of claim 12, wherein the at least one diffusible element comprises boron, silicon, phosphorus or a combination comprising at least one of the foregoing.

17. The method of claim 12, further comprising forming a metallurgical bond between the diffusion barrier layer and the substrate.

18. The method of claim 12, wherein the article is a turbine engine component.

19. The method of claim 12, wherein the article is a gas turbine engine component.

20. The method of claim 12, wherein the substrate comprises a turbine blade, vane, shroud, liner, combustor, transition piece, rotor component, exhaust flap, seal or fuel nozzle.
